(19) United States
(12) Patent Application Publication
(10) Pub. No.: US 2025/0238444 A1
(43) Pub. Date: Jul. 24, 2025

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventors: Kazuhiro HATAKEDA, Tokyo (JP); Chiho IWAHASHI, Tokyo (JP); Kenta MURAKAMI, Tokyo (JP); Misato SASAKI, Tokyo (JP); Toshinori MIYOSHI, Tokyo (JP)

(21) Appl. No.: 18/973,452

(22) Filed: Dec. 9, 2024

(30) Foreign Application Priority Data
Jan. 19, 2024 (JP) 2024-006978

(51) Int. Cl. G06F 16/3329; G06F 40/284

(52) U.S. Cl. CPC G06F 16/33295; G06F 40/284

(57) ABSTRACT

An information processing apparatus according to the present application includes a reception unit that receives information indicating a request of a user, a determination unit that determines whether to generate information indicating a response to the request indicated by the received information, and a providing unit that provides the user with response information generated by using a generative AI as the information indicating the response to the request in a case where determining to generate the information indicating the response. The determination unit determines whether to generate the information indicating the response to the request indicated by the information received by the reception unit on the basis of whether the request indicated by the information received by the reception unit is a request related to a first target set as a non-response target and a request related to a second target set as a response target.

### CROSS-REFERENCE TO RELATED APPLICATIONS

The present application claims priority to and incorporates by reference the entire contents of Japanese Patent Application No. 2024-006978 filed in Japan on Jan. 19, 2024.

### BACKGROUND OF THE INVENTION

### 1. Field of the Invention

The present invention relates to an information processing apparatus, an information processing method, and an information processing program.

### 2. Description of the Related Art

In recent years, a technique of responding to a request from a user by using a language model such as a transformer model has been developed. For example, Japanese Patent No. 7353695 discloses a technique of causing a language model to generate an answer to a question.

However, in the related art described above, an action in a case where it is not appropriate to make a response such as an answer is not considered, and there is room for improvement.

### SUMMARY OF THE INVENTION

An information processing apparatus according to the present application includes a reception unit that receives information indicating a request of a user, a determination unit that determines whether to generate information indicating a response to the request indicated by the received information, and a providing unit that provides the user with response information generated by using a generative AI as the information indicating the response to the request in a case where determining to generate the information indicating the response. The determination unit determines whether to generate the information indicating the response to the request indicated by the information received by the reception unit on the basis of whether the request indicated by the information received by the reception unit is a request related to a first target set as a non-response target and a request related to a second target set as a response target.

### BRIEF DESCRIPTION OF THE DRAWINGS

FIG. 1 is a diagram for describing information processing according to an embodiment;

FIG. 2 is a diagram illustrating an example of a configuration of an information processing system according to the embodiment;

FIG. 3 is a diagram illustrating an example of a configuration of an information processing apparatus according to the embodiment;

FIG. 4 is a diagram illustrating an example of a user information table stored in a user information storage unit of the information processing apparatus according to the embodiment;

FIG. 5 is a diagram illustrating an example of a non-response target table stored in a non-response target information storage unit of the information processing apparatus according to the embodiment;

FIG. 6 is a diagram illustrating an example of a non-response category set in advance for each category in the information processing apparatus according to the embodiment;

FIG. 7 is a diagram illustrating an example of instruction information used by a first generation processing unit in a processing unit of the information processing apparatus according to the embodiment and an output example of a third language model;

FIG. 8 is a diagram illustrating an example of instruction information used by a second generation processing unit in the processing unit of the information processing apparatus according to the embodiment and an output example of the third language model;

FIG. 9 is a diagram illustrating a relationship of processing by the first generation processing unit and the second generation processing unit in the processing unit of the information processing apparatus according to the embodiment;

FIG. 10 is a diagram illustrating an example of instruction information used by a third generation processing unit and the output example of the third language model in the processing unit of the information processing apparatus according to the embodiment, and is an example diagram in a case where a request indicated by request information is a question in a Q & A service, and non-response category information is a character string “question about Internet”;

FIG. 11 is a diagram illustrating an example of instruction information used for explicit non-response determination processing performed by a fourth generation processing unit of the processing unit in the information processing apparatus according to the embodiment as part of processing of a determination unit;

FIG. 12 is a diagram illustrating a flow of processing by an evaluation unit of the processing unit in the information processing apparatus according to the embodiment;

FIG. 13 is a diagram illustrating an example of the instruction information used for the explicit non-response determination processing performed by the determination unit of the processing unit in the information processing apparatus according to the embodiment;

FIG. 14 is a flowchart illustrating an example of information processing by the processing unit of the information processing apparatus according to the embodiment;

FIG. 15 is a flowchart illustrating an example of request processing by the processing unit of the information processing apparatus according to the embodiment;

FIG. 16 is a flowchart illustrating an example of non-response target information generation processing by the processing unit of the information processing apparatus according to the embodiment; and

FIG. 17 is a hardware configuration diagram illustrating an example of a computer that implements a function of the information processing apparatus according to the embodiment.

### DETAILED DESCRIPTION OF THE PREFERRED EMBODIMENTS

Hereinafter, modes (hereinafter referred to as “embodiments”) for implementing an information processing apparatus, an information processing method, and an information processing program according to the present application will be described in detail with reference to the drawings. Note that the information processing apparatus, the information processing method, and the information processing program according to the present application are not limited by the embodiments. Each of the embodiments can be appropriately combined within a range in which processing contents do not contradict each other. In the following embodiments, the same parts are denoted by the same reference signs, and redundant description will be omitted.

### [1. Example of Information Processing]

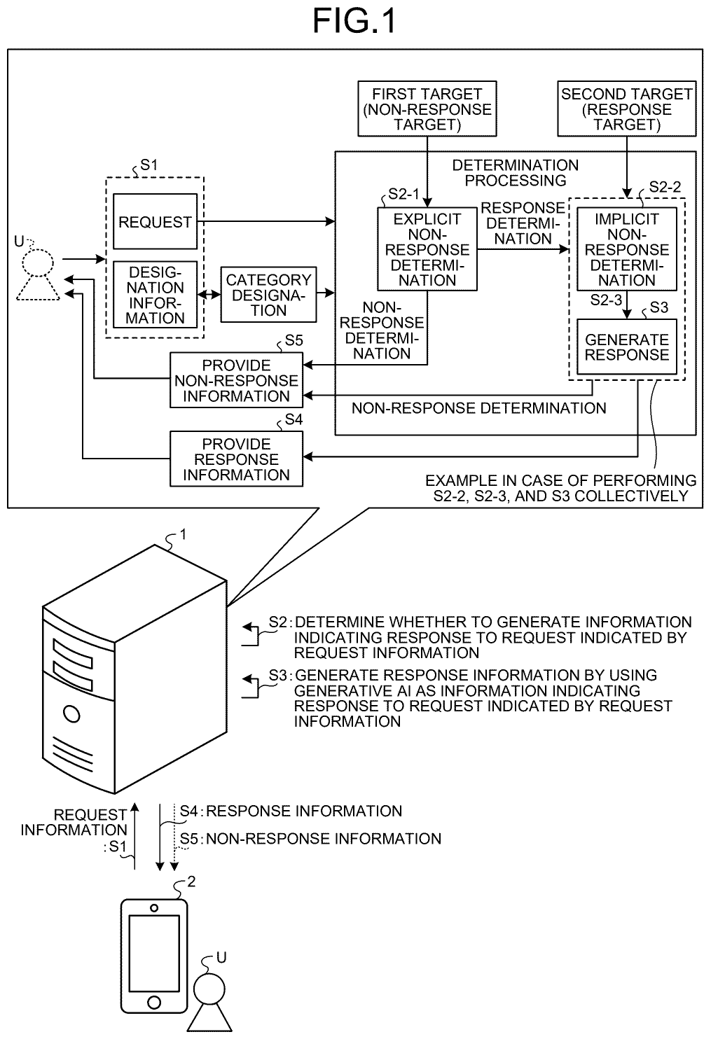

First, an example of information processing according to the embodiment will be described with reference to FIG. 1. FIG. 1 is a diagram for describing the information processing according to the embodiment.

The information processing apparatus 1 illustrated in FIG. 1 is an information processing apparatus that cooperates with each terminal device 2 of a user U and provides the user U with various services online, and is implemented by, for example, one or more servers or a cloud system. The terminal device 2 is, for example, a smartphone, a tablet, a personal computer, or the like.

The services provided by the information processing apparatus 1 are, for example, various services such as a question and answer (Q & A) services of “Yahoo Japan Chiebukuro” and the like, a content creation service, a customer support service, and a learning support service, but are not limited to such examples.

In various services, the information processing apparatus 1 generates response information, which is information indicating a response according to a request of the user U, by using generative artificial intelligence (AI), and provides the user U with the generated response information.

The generative AI is, for example, text generative AI. The text generative AI is, for example, a large-scale language model learned to estimate and output a next token from an input token string, and is, for example, a transformer-based model, a recurrent neural network (RNN)-based model, or the like, but may be a mixed model of the above or the like. The text generative AI may be a composite system combined with an identification machine or the like for preventing unauthorized use.

The transformer-based model is, for example, generative pre-trained transformer (GPT) (registered trademark), pathways language model version 2 (PaLM2), large language model meta AI (LLAMA), or the like, but is not limited to such examples. The RNN-based model is, for example, a reception weighted key value (RWKV) or the like, but is not limited to such an example.

Note that the generative AI is desirably learned not to include personal information and the like in a generation result. The generative AI is disposed in an external information processing apparatus. The information processing apparatus 1 uses the generative AI via an application programming interface (API), but the generative AI may be disposed in the information processing apparatus 1.

As illustrated in FIG. 1, the information processing apparatus 1 receives request information that is information indicating a request of the user U (Step S1). For example, the information processing apparatus 1 receives request information that is information indicating a request of the user U by receiving a use request from the terminal device 2.

The use request includes the request information. The request information includes, for example, information such as information indicating a question from the user U, information indicating an instruction by the user U, and information indicating a request from the user U, but is not limited to such examples.

The request information includes designation information that designates a category of the request. For example, in a case where the question from the user U is a question in a Q & A service or a customer support service, the use request includes designation information that designates a category of the question.

In a case where the instruction of the user U is a content creation instruction in a content creation service, the use request includes designation information that designates a category of content to be created. In a case where the instruction of the user U is an instruction of interactive learning in a learning support service, the use request includes designation information that designates a curriculum as a category of learning.

The designation information is, for example, information indicating a category of the request or information corresponding to the category of the request. The information corresponding to the category of the request is, for example, a uniform resource locator (URL) of a category in a service provided by the information processing apparatus 1 or information of a part of all of a domain name, but is not limited to such examples.

Subsequently, the information processing apparatus 1 determines whether to generate information indicating a response to the request indicated by the request information received in Step S1 (Step S2). In the following description, it is assumed that the request indicated by the request information received in Step S1 is a question in the Q & A service.

For example, the information processing apparatus 1 performs explicit non-response determination processing that is processing of determining whether the request indicated by the request information received in Step S1 is a request related to a first target set as a non-response target (Step S2-1). The first target is a target explicitly set as a non-response target.

The non-response target is a target not to be responded to in accordance with the request indicated by the request information. A plurality of first targets is set as non-response targets, but alternatively, one first target may be set. Such a first target is a target explicitly indicated as a non-response target. Therefore, the first target can be regarded as a determination criterion explicitly indicating a non-response target, and can be regarded as an explicit non-response determination criterion.

The first target that is an explicit exclusion determination criterion includes, for example, a target set as a non-response target for a designated category that is a category designated by the user U. The target set as the non-response target for the designated category is, for example, a target depending on the designated category. The information processing apparatus 1 specifies the designated category on the basis of the designation information included in the use request.

The target depending on the designated category is, for example, another category (a category other than the designated category) in which a response is not appropriate in the designated category, another category (a category other than the designated category) in which a boundary with the designated category is ambiguous and a probability of an appropriate response is equal to or less than a threshold, and the like, and may be described as a non-response category below. The non-response category is set in advance for each designated category.

The first target set as the non-response target includes, for example, a target that does not depend on the designated category in addition to the target set as the non-response target for the designated category. The target that does not depend on the designated category is, for example, violation of a law, violation of social morals, slander, defamation, and the like, but is not limited to such examples.

The target that depends on the designated category and the target that does not depend on the designated category may include a target for which a response using the generative AI is not appropriate. Examples of the target for which the response using the generative AI is not appropriate include medical care, health, and finance, but are not limited to such examples.

For example, the information processing apparatus 1 can determine whether the request indicated by the request information is a request related to the first target set as the non-response target by using a language model. Such a language model is an example of a first language model, and may be referred to as a first language model below. The first language model is, for example, a large-scale language model such as a transformer-based model or an RNN-based model, but is not limited to such examples.

The information processing apparatus 1 inputs to the first language model, as input information, information including instruction information giving an instruction on output of information indicating whether the request indicated by the request information included in the use request is a request related to the first target and information indicating the request included in the request information.

In this case, the information indicating whether the request is related to the first target is output from the first language model. In this manner, the information processing apparatus 1 can determine whether the request indicated by the request information is a request related to the first target set as the non-response target by using the first language model.

Input information input to AI such as a language model is called prompt. Hereinafter, the input information input to the language model may be referred to as prompt. The prompt is, for example, information indicating an instruction, a request, or the like given to the AI such as a language model in order to execute a specific task on the AI such as a language model.

For example, when the request indicated by the request information is a question of a specific category (designated category) in the Q & A service, the instruction information is information of a character string “You are an excellent filter. Please determine if the given question applies to the condition. \n#Condition\n Return “true” if the question applies to the condition, and return “false” if the question does not apply to the condition. \n Question about {category1}\n Question about {category2}, . . . ”. {category1} and {category2} are, for example, information indicating a non-response category set for the designated category.

The instruction information includes information indicating the first target, but the information indicating the first target may be included in the input information separately from the instruction information. The instruction information may include information indicating a request included in the request information.

The instruction information includes information indicating an output format. The information indicating the output format includes, for example, information output in a case where the request indicated by the request information is a request related to the first target, and information output in a case where the request indicated by the request information is not a request related to the first target.

The information output in a case where the request indicated by the request information is a request related to the first target is information indicating non-response determination, for example, “true”, and the information output in a case where the request indicated by the request information is not a request related to the first target is information indicating response determination, for example, “false”. However, the information is not limited to such examples.

The information indicating the output format may be information in a format for outputting specific information only when the request indicated by the request information is a request related to the first target. In this case, the specific information is information indicating the non-response determination, and the fact that the specific information is not output is information indicating the response determination. For example, the information indicating the output format is information of a character string “If the request indicated by the request information is a request related to the first target, ‘applicable’ is output, otherwise, nothing is output”, but is not limited to such an example. The information indicating the output format may be information indicating an output sample.

In the above example, the instruction information is included in the input information input to the first language model, but the first language model may be a language model learned to output information indicating whether the request indicated by the request information is a request related to the first target from the input information not including the instruction information. The first language model may be a language model learned to output information indicating whether the request indicated by the request information is a request related to the first target from the input information not including the instruction information and the information indicating the first target. In these cases, the language model is generated, for example, for each category, but is not limited to such examples.

Instead of or in addition to the first language model, the information processing apparatus 1 can determine whether the request indicated by the request information is a request related to the first target set as the non-response target by natural language processing not using the first language model. The natural language processing not using the first language model is, for example, keyword based natural language processing. The information processing apparatus 1 includes, for example, a first target dictionary including a plurality of keywords each directly or indirectly indicating a first target, and determines whether a keyword included in the first target dictionary is included in the request information.

In a case where the keyword included in the first target dictionary is included in the request information, the information processing apparatus 1 determines that the request indicated by the request information is a request related to the first target set as the non-response target, and otherwise, the information processing apparatus 1 determines that the request indicated by the request information is not a request related to the first target set as the non-response target.

The keyword based natural language processing may be natural language processing using a model other than the large-scale language model. The model in this case is a model generated by machine learning using learning information including, for each piece of input information, input information and information (label information) indicating whether the request indicated by the input information is a request related to the first target. Such a model is, for example, a gradient boosting decision tree (GBDT), a neural network, or the like, but is not limited to such examples.

Subsequently, in a case where determining in Step S2-1 that the request indicated by the request information is not a request related to the first target, the information processing apparatus 1 performs implicit non-response determination processing that is processing of determining whether the request indicated by the request information is a request related to the second target set as a response target (Step S2-2).

The second target is a target set as a response target, and it is determined whether the second target is not a non-response target by determining whether the second target is not a request related to the second target, and it can be said that the second target is a target implicitly indicating the non-response target. Therefore, it can be said that the second target to be a response target implicitly indicates a non-response determination criterion, and can be regarded as an implicit non-response determination criterion. For example, in a case where there is a category designated by the user U, the second target includes a designated category that is such a category.

For example, the information processing apparatus 1 can determine whether the request indicated by the request information is a request related to the second target set as the response target by using a language model. Such a language model is an example of a second language model, and may be referred to as a second language model below. The second language model is, for example, a large-scale language model such as a transformer-based model or an RNN-based model, but is not limited to such examples. Note that the second language model may be the same language model as the first language model.

The information processing apparatus 1 inputs to the second language model, as input information, information including instruction information giving an instruction on output of information indicating whether the request indicated by the request information included in the use request is a request related to the second target and information indicating a request indicated by the request information included in the use request.

In this case, the information indicating whether the request is related to the second target is output from the second language model. In this manner, the information processing apparatus 1 can determine whether the request indicated by the request information is a request related to the second target set as the non-response target by using the second language model.

For example, when the request indicated by the request information is a question of a specific category (designated category) in the Q & A service, the instruction information is information of a character string “You are an expert in {category}. Return ‘true’ if the question about {category} applies, or return ‘false’ if the question about {category} does not apply.” {category} is a designated category.

The instruction information includes information indicating the second target, but the information indicating the second target may be included in the input information separately from the instruction information. The instruction information may include information indicating a request included in the request information.

The instruction information includes information indicating an output format. The information indicating the output format includes, for example, information output in a case where the request indicated by the request information is a request related to the second target, and information output in a case where the request indicated by the request information is not a request related to the second target.

The information output in a case where the request indicated by the request information is a request related to the second target is information indicating response determination, for example, “true”, and the information output in a case where the request indicated by the request information is not a request related to the second target is information indicating non-response determination, for example, “false”. However, the information is not limited to such examples.

The information indicating the output format may be information in a format for outputting specific information only when the request indicated by the request information is a request related to the second target. In this case, the specific information is information indicating the response determination, and the fact that the specific information is not output is information indicating the non-response determination.

For example, the information indicating the output format is information of a character string “If the request indicated by the request information is a request related to the second target, ‘applicable’ is output, otherwise, nothing is output”, but is not limited to such an example. The information indicating the output format may be information indicating an output sample.

In the above example, the instruction information is included in the input information input to the second language model, but the second language model may be a language model learned to output information indicating whether the request indicated by the request information is a request related to the second target from the input information not including the instruction information.

The second language model may be a language model learned to output information indicating whether the request indicated by the request information is a request related to the second target from the input information not including the instruction information and the information indicating the second target. In these cases, the language model is generated, for example, for each category, but is not limited to such examples.

Instead of or in addition to the second language model, the information processing apparatus 1 can determine whether the request indicated by the request information is a request related to the second target set as the response target by natural language processing not using the second language model.

The natural language processing not using the second language model is, for example, keyword based natural language processing. The information processing apparatus 1 includes, for example, a second target dictionary including a plurality of keywords each directly or indirectly indicating a second target, and determines whether a keyword included in the second target dictionary is included in the request information.

In a case where the keyword included in the second target dictionary is included in the request information, the information processing apparatus 1 determines that the request indicated by the request information is a request related to the second target set as the response target, and otherwise, the information processing apparatus 1 determines that the request indicated by the request information is not a request related to the second target set as the response target.

The keyword based natural language processing may be natural language processing using a model other than the large-scale language model. The model in this case is a model generated by machine learning using learning information including, for each piece of input information, input information and information (label information) indicating whether the request indicated by the input information is a request related to the second target. Such a model is, for example, GBDT, a neural network, or the like, but is not limited to such examples.

Subsequently, the information processing apparatus 1 determines whether to generate response information that is information indicating a response to the request indicated by the request information received in Step S1 on the basis of a determination result of whether the request indicated by the request information is a request related to the second target in Step S2-2 (Step S2-3).

For example, in a case where determining in Step S2-2 that the request indicated by the request information is a request related to the second target, the information processing apparatus 1 determines to generate information indicating a response to the request indicated by the request information.

In a case where determining in Step S2-2 that the request indicated by the request information is not a request related to the second target, the information processing apparatus 1 determines not to generate information indicating a response to the request indicated by the request information.

In this manner, the information processing apparatus 1 first performs the explicit non-response determination processing, performs the implicit non-response determination processing when the explicit non-response determination criterion is not satisfied, and responds when the implicit non-response determination criterion is not satisfied. As a result, the information processing apparatus 1 can perform highly accurate response availability determination at low cost, and can suppress inappropriate responses.

Note that the information processing apparatus 1 can perform the explicit non-response determination processing and the implicit non-response determination processing in parallel. In this case, the information processing apparatus 1 determines whether to generate information indicating a response to the request indicated by the request information on the basis of a determination result of the explicit non-response determination processing and a determination result of the implicit non-response determination processing.

In this case, the information processing apparatus 1 determines to generate the information indicating the response to the request indicated by the request information in a case where the request indicated by the request information is not the request related to the first target and the request indicated by the request information is the request related to the second target, and otherwise, determines not to generate the information indicating the response to the request indicated by the request information. In this manner, the information processing apparatus 1 can also suppress an inappropriate response.

The information processing apparatus 1 can also perform processing in the order of the implicit non-response determination processing and the explicit non-response determination processing. In this case, the explicit non-response determination processing can be performed only in a case where it is determined in the implicit non-response determination processing that the request indicated by the request information is a request related to the second target. In this manner, the information processing apparatus 1 can also suppress an inappropriate response.

In this manner, the information processing apparatus 1 can determine whether to generate the information indicating the response to the request indicated by the request information on the basis of whether the request indicated by the request information is a request related to the first target set as the non-response target and a request related to the second target set as the response target.

Subsequently, in a case where it is determined in Step S2 to generate the information indicating the response to the request indicated by the request information, the information processing apparatus 1 generates the response information by using the generative AI as the information indicating the response to the request indicated by the request information (Step S3).

For example, the information processing apparatus 1 inputs to the generative AI, as input information, information including instruction information giving an instruction on output of information indicating a response to the request indicated by the request information and information indicating the request included in the request information, and causes the generative AI to generate the response information.

The request indicated by the request information is, for example, a question in a category of economy in the Q & A service, and is information of a character string “What is inflation? How does it affect the economy?”. In this case, the information processing apparatus 1 inputs to the generative AI, as the input information, information including the information of the character string “As an expert in {category}, you receive and answer questions about {category}.” as the instruction information and information including the information of the character string “What is inflation? How does it affect the economy?” as the information indicating the request included in the request information.

Note that {category} includes information indicating the designated category. The instruction information may include guideline information indicating a guideline for an answer. The guideline information includes, for example, information that gives an instruction on clarity, neutrality, and the like of the answer.

In the above example, an example has been described in which the processing of Step S2 and the processing of Step S3 are separately performed. However, a part or all of the processing of Step S2 may be included in the processing of Step S3.

For example, in a case where determining in Step S2-1 that the request indicated by the request information is not a request related to the first target, the information processing apparatus 1 inputs to the generative AI, as the input information, information including instruction information giving an instruction on generation of information indicating a response to the request indicated by the request information in a case where the request is a request related to the second target, so that the information processing apparatus 1 can collectively perform the processing of Step S2-2, Step S2-3, and Step S3 as in the processing described in the balloons in FIG. 1. In this case, the second language model described above is generative AI, and the processing of Step S2-2, Step S2-3, and Step S3 can be collectively performed by inputting the input information (prompt) to the generative AI once.

In this case, the instruction information included in the input information is, for example, information of a character string “#As an expert in {category}, you receive questions or consultation about {category} and answer it. Do not answer questions except the {category} category.”, but is not limited to such an example. Note that {category} includes information indicating the designated category. The instruction information may include guideline information.

In a case where the request indicated by the request information is not a request related to the first target but a request related to the second target, the information processing apparatus 1 inputs to the generative AI, as input information, information including instruction information giving an instruction on generation of information indicating a response to the request indicated by the request information, so that the information processing apparatus 1 can collectively perform the processing of Steps S2 and S3. In this case, the first language model and the second language model described above are generative AI, and the processing of Step S2 and Step S3 can be collectively performed by inputting the input information (prompt) to the generative AI once.

In this case, the instruction information included in the input information is, for example, information of a character string “#You are a good AI assistant. You determine to which {category group} a given question applies; if the given question does not apply to any {category group}, then as an expert on {category}, receive and answer questions about {category}. Do not answer questions except the {category} category”, but is not limited to such an example. Note that {category group} includes information indicating one or more first targets, and {category} includes information indicating a designated category. The instruction information may include guideline information.

Subsequently, in a case where the response information is generated by using the generative AI in Step S3, the information processing apparatus 1 provides the user U with the response information generated by using the generative AI (Step S4). For example, the information processing apparatus 1 provides the user U with the response information generated by using the generative AI by transmitting the response information generated by using the generative AI in Step S3 to the terminal device 2 that has transmitted the use request.

For example, in a case where the request indicated by the request information is a question in the Q & A service, when the user U accesses a page indicating an answer to the question from the user U, the information processing apparatus 1 can provide the user U with the page indicating the answer to the question of the user U.

In a case where the response information is not generated by using the generative AI in Step S3, the information processing apparatus 1 provides the user U with the non-response information (Step S5). For example, in a case where determining in Step S2-1 that the request indicated by the request information is a request related to the first target, or in a case where it is determined in Step S2-2 that the request indicated by the request information is not a request related to the second target, the information processing apparatus 1 provides the user U with the non-response information.

The non-response information is, for example, information of character information “We are sorry. The target is a non-response target, and the request cannot be responded to”. For example, in a case where the request indicated by the request information is a request of a Q & A service, the non-response information is, for example, information of character information “We are sorry. The question cannot be answered because it is a question not to applicable for answer”. Note that the non-response information may include information explicitly indicating that the request is related to the first target or is not related to the second target.

In the above explicit non-response determination criterion, in addition to the fixed first target that does not depend on the designated category, a category that is a category other than the designated category and is set in advance for each designated category is included as the first target that depends on the designated category. Thus, non-response accuracy for an inappropriate request can be enhanced.

On the other hand, the above first target depending on the designated category is a non-response category that is a category set in advance as a non-response category for each designated category and is a category other than the designated category, and is an abstract concept. Therefore, a non-response coverage is low, and there is a possibility that the information processing apparatus 1 cannot reject an inappropriate request.

For example, there is a possibility that the information processing apparatus 1 cannot reject a request that should not be responded, such as a request against social morals or a request for a response that becomes slander in the non-response category, and a request for which the response using the generative AI is not appropriate in the non-response category. The request for which the response using the generative AI is not appropriate is, for example, a request including topics such as medical care, health, and finance in a non-response category, but is not limited to such examples.

Therefore, the information processing apparatus 1 is configured to be able to perform generation processing of generating non-response target information indicating a new non-response target on the basis of non-response category information indicating the non-response category associated with the designated category. Thus, the non-response accuracy for an inappropriate request can be further enhanced. Hereinafter, the generation processing executed by the information processing apparatus 1 will be specifically described.

The generation processing executed by the information processing apparatus 1 includes first generation processing of generating, as new non-response target information, risk information indicating a risk from non-response category information indicating a non-response category, and second generation processing of extracting a feature word from the non-response category information and generating new non-response target information from the extracted feature word.

First, the first generation processing will be described. In the first generation processing, for example, the information processing apparatus 1 generates new non-response target information by using a language model. Such a language model is an example of a third language model, and may be referred to as a third language model below. The third language model is, for example, a large-scale language model such as a transformer-based model or an RNN-based model. The third language model may be the same as one or more of the generative AI, the first language model, or the second language model described above.

For example, the information processing apparatus 1 generates, as new non-response target information, risk information that is information indicating a risk in the non-response category from the non-response category information by using the third language model. For example, the information processing apparatus 1 can input information including non-response category information to the third language model as input information, and can cause the third language model to generate and output risk information that is information indicating a risk in the non-response category as new non-response target information. Hereinafter, information indicating a risk may be referred to as risk information.

For example, the information processing apparatus 1 inputs information including instruction information giving an instruction on output of a risk in one or more non-response categories to the third language model as input information, and causes the third language model to generate and output risk information in the non-response category. For example, in a case where the non-response category is adult, gamble, or the like, the instruction information includes information of a character string “Please output possible risks based on given category information. \n#Category information\n Adult\n Gamble”.

The third language model may be, for example, a model learned to output the non-response target information when information including the non-response category information is input as the input information. In this case, the third language model is learned by using, for example, learning information including information including non-response category information and one or more pieces of non-response target information for each non-response category. The one or more pieces of non-response target information are used as teacher data (label).

For example, the information processing apparatus 1 can generate one or more pieces of risk information for each non-response category by using the third language model. The information processing apparatus 1 can include, in the designation information, information that designates the number of pieces of non-response category information to be generated by the third language model.

For example, the information processing apparatus 1 can cause the third language model to generate, as risk information, information indicating possible risks considered by a manager of a service that makes a response according to a request for the designated category.

For example, it is assumed that the request indicated by the request information is a question in the Q & A service, the designated category is television, and the non-response category is adult and gamble. In this case, the instruction information included in the input information includes information of a character string “You are a manager who answers questions about television in the Q & A service. Please output the possible risks based on the given category information”.

In a case where the information processing apparatus 1 obtains a plurality of pieces of risk information by using the third language model, the information processing apparatus 1 aggregates the plurality of pieces of risk information by using the third language model into n or less pieces of risk information, the n being a number set in advance as the non-response target information. The number n is an integer of one or more. For example, the information processing apparatus 1 can input information including instruction information that groups the plurality of pieces of risk information into n pieces of risk information to the third language model as input information, and output the n pieces of risk information aggregated in the third language model.

For example, in a case where the information processing apparatus 1 causes the third language model to generate, as risk information, the information indicating possible risks considered by the manager of the Q & A service described above, for example, the information processing apparatus 1 can output n pieces of risk information aggregated in the third language model by inputting to the third language model, as input information, instruction information including information of a character string “You are a manager who answers questions about television in the Q & A service. Please aggregate the risks into five risks to be emphasized in continuing the service on the basis of the given risk information.” and a plurality of pieces of risk information.

Subsequently, the second generation processing will be described. In the second generation processing, the information processing apparatus 1 extracts feature words (for example, keywords or characteristic phrases) from the non-response category information, and generates new non-response target information from the extracted feature word.

The information processing apparatus 1 divides the non-response category information to extract a feature word, and generates new non-response target information by using the feature word. For example, the information processing apparatus 1 can perform processing of extracting a feature word from the non-response category information and generating information partially including each feature word as a plurality of pieces of new non-response target information by using the third language model.

For example, it is assumed that the request indicated by the request information is a question in the Q & A service, and the non-response category information is a character string “question about Internet”. In this case, for example, the information processing apparatus 1 can cause the third language model to generate a plurality of pieces of new non-response target information by inputting, to the third language model, information of a character string “#Command Please extract feature words that are important words from given keywords and create subdivided keywords. \n\n#Keyword\n question about Internet”. The plurality of pieces of new non-response target information in this case is, for example, information of the character string “Internet technology”, information of the character string “Internet service”, and the like, but is not limited to such examples.

For example, the information processing apparatus 1 can generate the plurality of pieces of new non-response target information on a rule basis instead of the third language model. For example, the information processing apparatus 1 includes a feature word dictionary including a plurality of keywords or phrases for each feature word, and can extract a plurality of keywords or phrases associated with a feature word included in the feature word dictionary among the non-response category information as the plurality of pieces of new non-response target information.

In a case where there is a plurality of pieces of non-response category information, the information processing apparatus 1 can perform processing of generating the plurality of pieces of non-response target information by using the third language model for each non-response category, but can also collectively perform processing of generating the plurality of pieces of non-response target information by using the third language model for the plurality of non-response categories.

On the basis of the non-response accuracy for each combination of two or more pieces of non-response target information among the plurality of pieces of non-response category information generated as described above, the information processing apparatus 1 can select two or more pieces of non-response target information to be used in Step S2-1 among the plurality of pieces of non-response target information generated as described above. In this case, the information processing apparatus 1 determines in Step S2-1 whether the request indicated by the request information is a request related to the non-response target on the basis of the selected two or more pieces of response target information.

For example, the information processing apparatus 1 can evaluate the non-response accuracy for each combination of two or more pieces of non-response target information. For example, the information processing apparatus 1 can evaluate the non-response accuracy for each combination of two or more pieces of response target information by using a plurality of pieces of evaluation request information. Hereinafter, a combination of two or more pieces of non-response target information may be referred to as a non-response target information combination.

Each piece of evaluation request information is information indicating a first request that is a request related to the non-response target in the designated category, information indicating a second request that is a request related to the response target in the designated category, or information indicating a third request that is a request related to the non-response target regardless of the designated category.

The information processing apparatus 1 determines whether it is determined that the request indicated by the evaluation request information is a request related to a non-response target in the explicit non-response determination processing using the non-response target information combination. The explicit non-response determination processing using the non-response target information combination is, for example, processing of using each of the plurality of pieces of non-response target information included in the non-response target information combination as the first target.

In a case where determining that the first request or the third request indicated by the evaluation request information is a request related to a non-response target in the explicit non-response determination processing using the non-response target information combination, the information processing apparatus 1 sets an evaluation of the non-response target information combination to 1, and otherwise, sets the evaluation of the non-response target information combination to 0.

In a case where determining that the second request indicated by the evaluation request information is not a request related to a non-response target in the explicit non-response determination processing using a prompt including the non-response target information combination, the information processing apparatus 1 sets the evaluation of the non-response target information combination to 1, and otherwise, sets the evaluation of the non-response target information combination to 0.

The information processing apparatus 1 can calculate the non-response accuracy by aggregating evaluation results and dividing the aggregation results by the number of evaluations. The information processing apparatus 1 can change a weight depending on whether the request indicated by the evaluation request information is the first request, the second request, or the third request, and aggregate the evaluation results by weighted addition.

The evaluation request information may be limited to information indicating the first request, or may be limited to two or more pieces of information of the information indicating the first request, the information indicating the second request, or the information indicating the third request. The evaluation is not limited to 0 and 1, and may be, for example, −1 and 1, or a combination of other values.

The information processing apparatus 1 can also evaluate the non-response accuracy of the non-response target information combination by using the language model in a case where the keyword based natural language processing is used to determine, for example, whether the request indicated by the request information from each user U is a request related to the non-response target in the explicit non-response determination processing using the non-response target information combination.

For example, the information processing apparatus 1 can evaluate the non-response accuracy of the non-response target information combination for each non-response target information combination by using the third language model on the basis of the information indicating the request included in the request information from each user U and a determination result of the keyword based natural language processing.

For example, the information processing apparatus 1 inputs as the input information, to the third language model, information including instruction information that gives an instruction on determination as to whether any of the two or more pieces of non-response target information indicated by the non-response target information combination is included in the request information from the user U, and causes the third language model to output information indicating the non-response accuracy of the two or more pieces of response target information indicated by the non-response target information combination.

The information processing apparatus 1 selects a non-response target information combination having the highest non-response accuracy among the non-response accuracy of each non-response target information combination as the non-response target information combination used in Step S2-1.

The information processing apparatus 1 can also select a non-response target information combination having non-response accuracy equal to or greater than a threshold for each non-response target information combination as a combination of the two or more pieces of non-response target information to be used in Step S2-1 randomly or in accordance with a predetermined rule.

In this manner, the information processing apparatus 1 according to the embodiment receives the information indicating the request of the user U, determines whether to generate the information indicating the response to the request indicated by the received information, and in a case where determining to generate the information indicating the response, the information processing apparatus 1 provides the user U with the response information generated by using the generative AI as the information indicating the response to the request. The information processing apparatus 1 determines whether to generate the information indicating the response to the request indicated by the received information on the basis of whether the request indicated by the received information is a request related to the first target set as the non-response target and a request related to the second target set as the response target. As a result, the information processing apparatus 1 can suppress an inappropriate response.

The information processing apparatus 1 according to the embodiment generates non-response target information indicating a non-response target, receives information indicating a request of the user U, and determines whether the request indicated by the received information is a request related to the non-response target on the basis of the plurality of pieces of generated non-response target information. As a result, the information processing apparatus 1 can suppress an inappropriate response.

Hereinafter, a configuration and the like of an information processing system including the information processing apparatus 1 and the terminal devices 2 that perform such processing will be described in detail.

### [2. Configuration of Information Processing System]

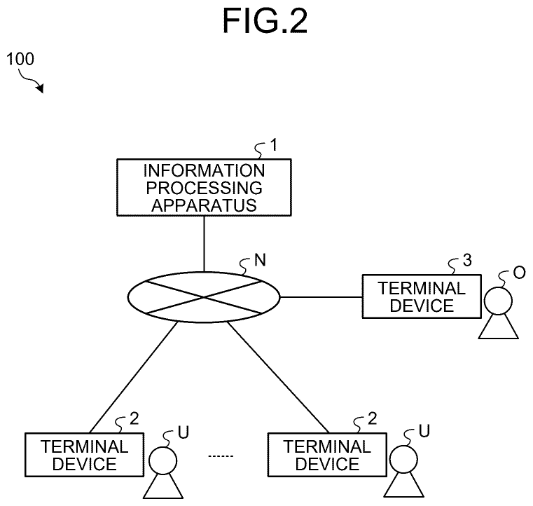

FIG. 2 is a diagram illustrating an example of a configuration of the information processing system according to the embodiment. As illustrated in FIG. 2, an information processing system 100 according to the embodiment includes an information processing apparatus 1, a plurality of terminal devices 2, and a terminal device 3.

The plurality of terminal devices 2 is used by different users U. The terminal device 3 is used, for example, by an employee O of an operating company of the information processing apparatus 1. The terminal devices 2 and 3 are, for example, a notebook personal computer (PC), a desktop PC, a smartphone, a tablet PC, and a wearable device. The wearable device is, for example, a smart glass, a smart watch, or the like, but is not limited to such examples.

Each of the information processing apparatus 1, the terminal devices 2, and the terminal device 3 is connected to communicate with each other in a wired or wireless manner via a network N. Note that the information processing system 100 illustrated in FIG. 2 may include a plurality of information processing apparatuses 1 and the like.

The network N includes, for example, a wide area network (WAN) such as the Internet and a mobile communication network such as long term evolution (LTE), fourth generation (4G), or fifth generation (5G), but is not limited to such examples.

The terminal devices 2 and 3 can be connected to the network N via short-range wireless communication such as a mobile communication network, Bluetooth (registered trademark), or a wireless local area network (LAN), and can communicate with the information processing apparatus 1 and the like.

### [3. Configuration of Information Processing Apparatus 1]

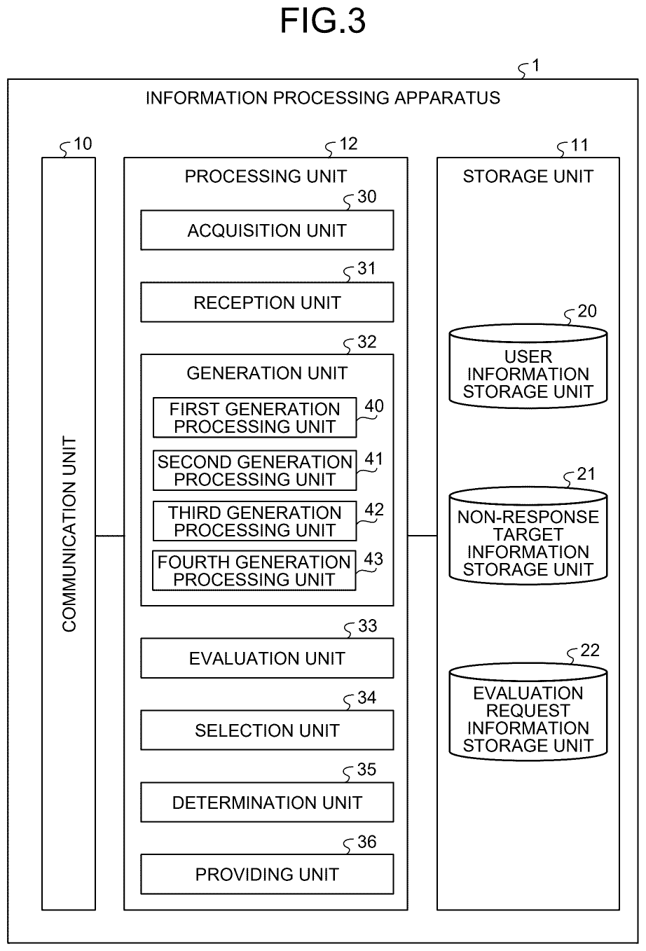

FIG. 3 is a diagram illustrating an example of a configuration of the information processing apparatus 1 according to the embodiment. As illustrated in FIG. 3, the information processing apparatus 1 includes a communication unit 10, a storage unit 11, and a processing unit 12.

### [3.1. Communication Unit 10]

The communication unit 10 is implemented by, for example, a communication module, a network interface card (NIC), or the like. Then, the communication unit 10 is connected to the network N in a wired or wireless manner, and transmits and receives information to and from various other devices. For example, the communication unit 10 transmits and receives information to and from each of the terminal device 2 and the terminal device 3 via the network N.

### [3.2. Storage Unit 11]

The storage unit 11 is implemented by, for example, a semiconductor memory element such as a random access memory (RAM) or a flash memory, or a storage device such as a hard disk or an optical disk. The storage unit 11 includes a user information storage unit 20, a non-response target information storage unit 21, and an evaluation request information storage unit 22.

### [3.2.1. User Information Storage Unit 20]

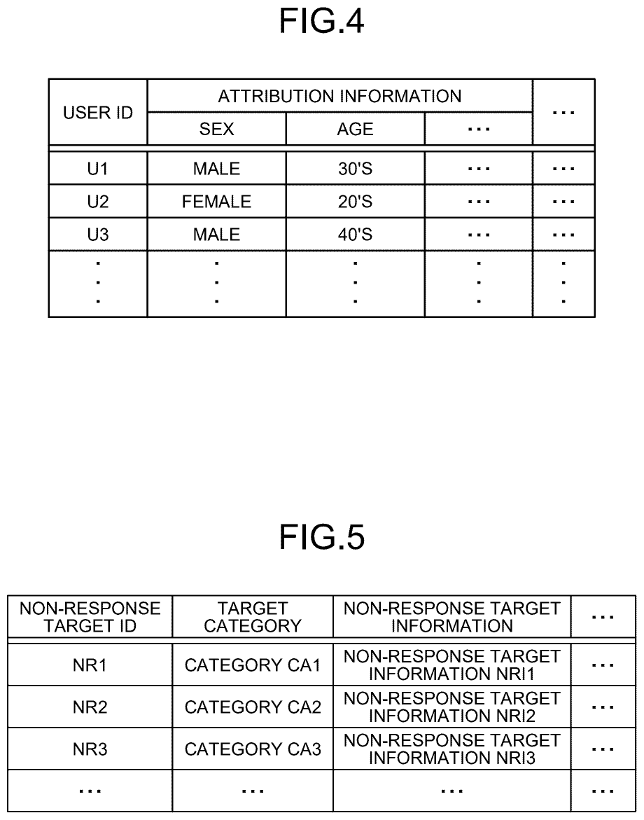

The user information storage unit 20 stores user information including information related to the user U. FIG. 4 is a diagram illustrating an example of a user information table stored in the user information storage unit 20 of the information processing apparatus 1 according to the embodiment. As illustrated in FIG. 4, the user information table stored in the user information storage unit 20 includes items such as “user ID” and “attribute information”.

The “user ID” is identification information that identifies the user U. The “attribute information” is attribute information of the user U corresponding to the “user ID”, and includes, for example, information of a psychographic attribute, information of a demographic attribute, and the like. The demographic attribute is, for example, gender, age, place of residence, occupation, and the like, and the psychographic attribute is objects of interest such as travel, clothes, cars, and religion, a lifestyle, an idea, a tendency of an idea, and the like.

### [3.2.2. Non-Response Target Information Storage Unit 21]

A non-response target information storage unit 21 stores information indicating various non-response targets. FIG. 5 is a diagram illustrating an example of a non-response target table stored in the non-response target information storage unit 21 of the information processing apparatus 1 according to the embodiment.

In the example illustrated in FIG. 5, the non-response target table stored in the non-response target information storage unit 21 includes information of items such as “non-response target ID”, “target category”, and “non-response target information”. The “non-response target ID” is an identifier for identifying a non-response target, and is information attached to each non-response target. The non-response target includes the first target described above.

The “target category” is information indicating a category associated with the non-response target, and is set to a blank (null) in a case where there is no category associated with the non-response target. The “non-response target information” is information indicating a non-response target, and is, for example, non-response category information indicating a non-response category associated with the target category in advance by the employee O or the like as a non-response category, non-response target information generated by the processing unit 12, or the like, but is not limited to such examples.

### [3.2.3. Evaluation Request Information Storage Unit 22]

The evaluation request information storage unit 22 stores various evaluation request information. The evaluation request information is, for example, information indicating the first request that is a request related to the non-response target in the designated category, information indicating the second request that is a request related to the response target in the designated category, or information indicating the third request that is a request related to the non-response target regardless of the designated category.

### [3.3. Processing Unit 12]

The processing unit 12 is a controller, and is implemented by, for example, a processor such as a central processing unit (CPU) or a micro processing unit (MPU) executing various programs (corresponding to an example of an information processing program) stored in a storage device inside the information processing apparatus 1 by using a RAM or the like as a work area.

The processing unit 12 is a controller, and a part or all of the processing unit 12 may be implemented by an integrated circuit such as an application specific integrated circuit (ASIC), a field programmable gate array (FPGA), or a general purpose graphic processing unit (GPGPU).

As illustrated in FIG. 3, the processing unit 12 includes an acquisition unit 30, a reception unit 31, a generation unit 32, an evaluation unit 33, a selection unit 34, a determination unit 35, and a providing unit 36, and implements or executes a function and an action of information processing described below. Note that the internal configuration of the processing unit 12 is not limited to the configuration illustrated in FIG. 3, and may be another configuration as long as the configuration performs information processing to be described later.

### [3.3.1. Acquisition Unit 30]

The acquisition unit 30 acquires various types of information from an external information processing apparatus, the terminal devices 2 and 3, and the like via the network N and the communication unit 10.

For example, the acquisition unit 30 acquires information of the user U from the external information processing apparatus or the terminal device 2, and stores the acquired information of the user U in the user information storage unit 20. The acquisition unit 30 acquires the non-response category information from the external information processing apparatus or the terminal device 3, and stores the acquired non-response category information in the non-response target information storage unit 21. The acquisition unit 30 acquires the evaluation request information from the external information processing apparatus or the terminal device 3, and stores the acquired evaluation request information in the evaluation request information storage unit 22.

The acquisition unit 30 acquires various types of information from the storage unit 11. For example, the acquisition unit 30 acquires information of the user U from the user information storage unit 20. The acquisition unit 30 acquires the non-response target information corresponding to the designated category from the non-response target information storage unit 21. The acquisition unit 30 acquires the evaluation request information from the evaluation request information storage unit 22.

### [3.3.2. Reception Unit 31]

The reception unit 31 receives various requests and information. For example, the reception unit 31 receives request information that is information indicating the request of the user U. For example, the reception unit 31 receives the request information included in the use request by receiving the use request. The request information includes, for example, information such as information indicating a question from the user U, information indicating an instruction by the user U, and information indicating a request from the user U, but is not limited to such examples.

The request information includes designation information that designates a category of the request. The reception unit 31 specifies the designated category on the basis of the designation information included in the received use request. For example, in a case where the question from the user U is a question in a Q & A service or a customer support service, the use request includes designation information that designates a category of the question.

In a case where the instruction of the user U is a content creation instruction in a content creation service, the use request includes designation information that designates a category of content to be created. In a case where the instruction of the user U is an instruction of interactive learning in a learning support service, the use request includes designation information that designates a curriculum as a category of learning.

The designation information is, for example, information indicating a category of the request or information corresponding to the category of the request. The information corresponding to the category of the request is, for example, a URL of a category in a service provided by the information processing apparatus 1 or information of a part or all of a domain name, but is not limited to such examples.

### [3.3.3. Generation Unit 32]

The generation unit 32 generates various types of information. For example, the generation unit 32 generates non-response target information as information indicating the first target. The non-response target information is information indicating a non-response target that is a target of non-response to the request indicated by the request information received by the reception unit 31.

The generation unit 32 generates non-response target information indicating a new non-response target. For example, the generation unit 32 generates non-response target information indicating a new non-response target on the basis of non-response category information indicating a non-response category that is different from the designated category as a category designated by the user U and is associated with the designated category in advance as a non-response category.

For example, the generation unit 32 can generate risk information indicating a risk from non-response category information indicating a non-response category as new non-response target information. The generation unit 32 can extract a feature word from the non-response category information and generate new non-response target information from the extracted feature word. For example, the generation unit 32 generates information partially including the feature word extracted from the non-response category information as the non-response target information.

The generation unit 32 generates non-response target information as information indicating the first target by using the third language model. For example, the generation unit 32 inputs information including non-response category information indicating the non-response category to the third language model, and causes the third language model to generate the non-response target information.

In a case where the determination unit 35 determines to generate the information indicating the response to the request indicated by the request information received by the reception unit 31, the generation unit 32 generates the response information by using the generative AI as the information indicating the response to the request indicated by the request information received by the reception unit 31.

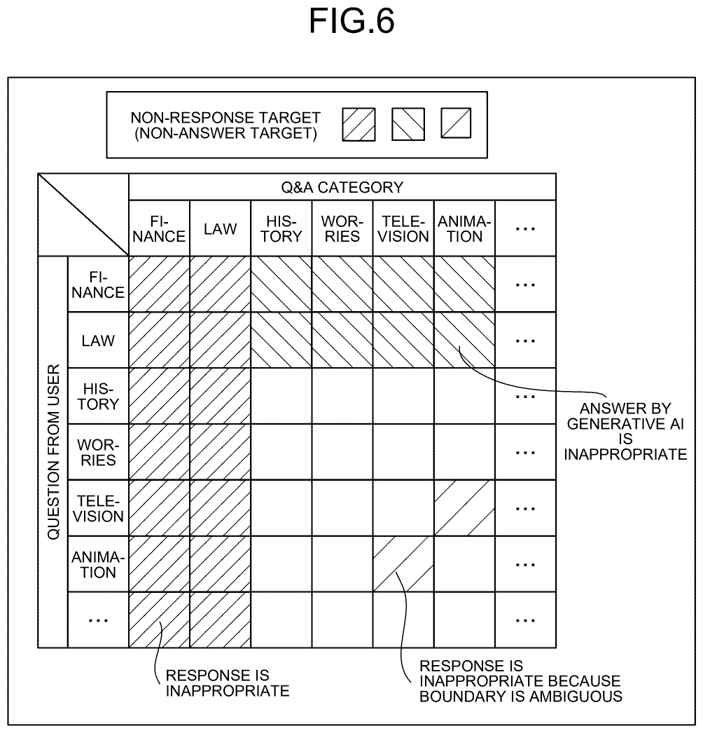

FIG. 6 is a diagram illustrating an example of the non-response category set in advance for each category in the information processing apparatus 1 according to the embodiment. The example illustrated in FIG. 6 illustrates an example of a non-response category set in advance for each category in a case where the request indicated by the request information is a question in the Q & A service, and a category of finance or law is set as the non-response category regardless of the category of the question from the user U.

In the example illustrated in FIG. 6, in a case where the category of the question from the user U is finance or law, all categories other than the category are set as the non-response category, in a case where the category of the question from the user U is television, animation is set as the non-response category, and in a case where the category of the question from the user U is animation, television is set as the non-response category. Note that the non-response category set in advance for each category is not limited to the examples illustrated in FIG. 6.

As illustrated in FIG. 3, the generation unit 32 includes a first generation processing unit 40 that generates a plurality of pieces of risk information indicating a risk in the non-response category, and a second generation processing unit 41 that aggregates the plurality of pieces of risk information generated by the first generation processing unit 40 into n pieces of risk information. The generation unit 32 includes a third generation processing unit 42 that generates information partially including a feature word extracted from the non-response category information as new non-response target information, and a fourth generation processing unit 43 that causes the generative AI to generate response information that is information indicating a response to the request indicated by the request information.

### [3.3.3.1. First Generation Processing Unit 40]

The first generation processing unit 40 generates risk information indicating a risk in the non-response category by using the third language model. The third language model is, for example, a large-scale language model such as a transformer-based model or an RNN-based model. The third language model may be the same as one or more of the generative AI, the first language model, or the second language model described above.

For example, the first generation processing unit 40 generates, as new non-response target information, risk information that is information indicating a risk in the non-response category from the non-response category information by using the third language model. For example, the first generation processing unit 40 can input information including non-response category information to the third language model as input information, and can cause the third language model to generate and output risk information that is information indicating a risk in the non-response category as new non-response target information.

For example, the first generation processing unit 40 inputs information including instruction information giving an instruction on output of a risk in one or more non-responsive categories to the third language model as input information, and causes the third language model to generate and output risk information in the non-responsive category.

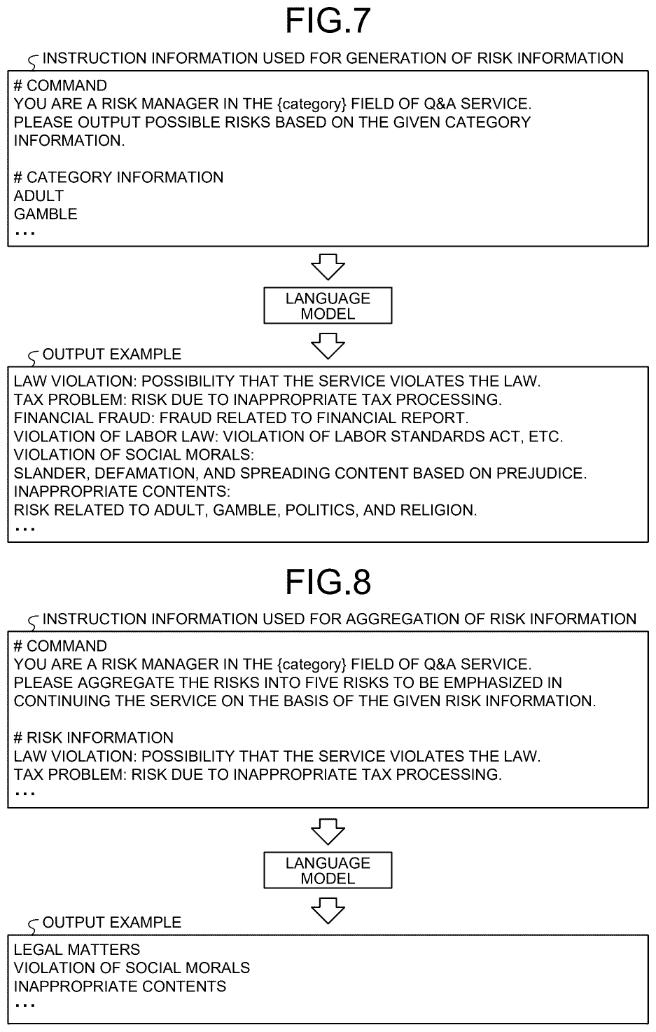

FIG. 7 is a diagram illustrating an example of the instruction information used by the first generation processing unit 40 in the processing unit 12 of the information processing apparatus 1 according to the embodiment and an output example of the third language model. In FIG. 7, for example, in a case where the non-response category is adult, gamble, or the like, the instruction information includes information of a character string “#Command\n You are a risk manager in the {category} field of Q & A service. \n Please output possible risks based on the given category information. \n\n #Category information\n Adult \n Gamble . . . ”. In FIG. 7, {category} is information indicating the designated category.

As illustrated in FIG. 7, the first generation processing unit 40 can also cause the third language model to generate, as risk information, information indicating possible risks considered by a manager of a service that makes a response according to a request for the designated category.

The third language model may be, for example, a model learned to output the non-response target information when information including the non-response category information is input as the input information. In this case, the third language model is learned by using, for example, learning information including information including non-response category information and one or more pieces of non-response target information for each non-response category. The one or more pieces of non-response target information are used as teacher data (label).

For example, the first generation processing unit 40 can generate one or more pieces of risk information for each non-response category by using the third language model. The first generation processing unit 40 can include, in the designation information, information that designates the number of pieces of non-response category information to be generated by the third language model.

### [3.3.3.2. Second Generation Processing Unit 41]

The second generation processing unit 41 aggregates the plurality of pieces of risk information generated by the first generation processing unit 40 into n or less pieces of risk information by using a language model, the n being a number set in advance as non-response target information. The number n is an integer of one or more.

For example, in a case where more than n pieces of risk information are generated by the first generation processing unit 40, the second generation processing unit 41 aggregates a plurality of pieces of risk information generated by the first generation processing unit 40 into n or less pieces of risk information by using the third language model, the n being a number set in advance as non-response target information.

For example, the second generation processing unit 41 can input information including instruction information that groups the plurality of pieces of risk information into n pieces of risk information generated by the first generation processing unit 40 to the third language model as input information, and output the n pieces of risk information aggregated in the third language model.

FIG. 8 is a diagram illustrating an example of the instruction information used by the second generation processing unit 41 in the processing unit 12 of the information processing apparatus 1 according to the embodiment and an output example of the third language model. In FIG. 8, the instruction information is information of a character string “#Command\n You are a risk manager in the {category} field of the Q & A service. \n Please aggregate the risks that must be emphasized in continuing the service into five risks on the basis of the given risk information. \n\n#Risk information\n Law violation: possibility that the service violates the law. \n Tax problem: risk due to inappropriate tax processing . . . ”, and by inputting information including the instruction information and information indicating a request included in the request information to the third language model as input information, n pieces of risk information aggregated in the third language model can be output.

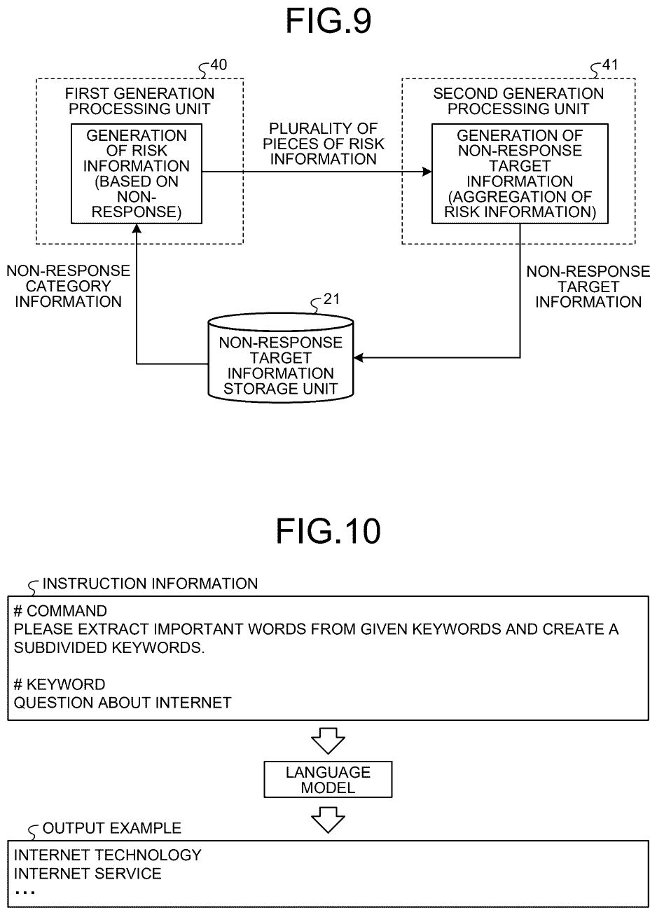

FIG. 9 is a diagram illustrating a relationship of processing by the first generation processing unit 40 and the second generation processing unit 41 in the processing unit 12 of the information processing apparatus 1 according to the embodiment. As illustrated in FIG. 9, the first generation processing unit 40 generates a plurality of pieces of risk information on the basis of the non-response category information stored in the non-response target information storage unit 21. The second generation processing unit 41 aggregates the plurality of pieces of risk information generated by the first generation processing unit 40 into n pieces of risk information, and stores an aggregation result in the non-response target information storage unit 21 as n pieces of non-response target information.

### [3.3.3.3. Third Generation Processing Unit 42]

The third generation processing unit 42 generates information partially including a feature word (for example, keywords or characteristic phrases) extracted from the non-response category information as new non-response target information.

For example, the third generation processing unit 42, divides the non-response category information to extract a feature word, and generates new non-response target information by using the feature word. For example, the third generation processing unit 42 can perform processing of extracting a feature word from the non-response category information and generating information partially including each feature word as a plurality of pieces of new non-response target information by using the third language model.

FIG. 10 is a diagram illustrating an example of instruction information used by the third generation processing unit 42 and the output example of the third language model in the processing unit 12 of the information processing apparatus 1 according to the embodiment, and is an example in a case where a request indicated by request information is a question in a Q & A service, and non-response category information is a character string “question about Internet”.

In this case, as illustrated in FIG. 10, for example, the third generation processing unit 42 can cause the third language model to generate a plurality of pieces of new non-response target information by inputting, to the third language model, information of a character string “#Command\n Please extract important words from given keywords and create subdivided keywords. \n\n#Keyword\n Question about Internet”. As illustrated in FIG. 9, the plurality of pieces of new non-response target information in this case is, for example, information of the character string “internet technology”, information of the character string “internet service”, and the like, but is not limited to such examples.

For example, the third generation processing unit 42 can generate the plurality of pieces of new non-response target information on a rule basis instead of the third language model. For example, the third generation processing unit 42 includes a feature word dictionary including a plurality of keywords or phrases for each feature word, and can extract a plurality of keywords or phrases associated with a feature word included in the feature word dictionary among the non-response category information as the plurality of pieces of new non-response target information.

In a case where there is a plurality of pieces of non-response category information, the third generation processing unit 42 can perform processing of generating the plurality of pieces of non-response target information by using the third language model for each non-response category, but can also collectively perform processing of generating the plurality of pieces of non-response target information by using the third language model for the plurality of non-response categories.

### [3.3.3.4. Fourth Generation Processing Unit 43]

The fourth generation processing unit 43 generates, by using the generative AI, response information that is information indicating a response to the request indicated by the request information.

For example, the fourth generation processing unit 43 inputs to the generative AI, as input information, information including instruction information giving an instruction on output of information indicating a response to the request indicated by the request information and information indicating the request included in the request information, and causes the generative AI to generate the response information.

The request indicated by the request information is, for example, a question in a category of economy in the Q & A service, and is information of a character string “What is inflation? How does it affect the economy?”. In this case, the fourth generation processing unit 43 inputs to the generative AI, as the input information, information including the information of the character string “As an expert in {category}, you receive and answer questions about {category}.” as the instruction information and information including the information of the character string “What is inflation? How does it affect the economy?” as the information indicating the request included in the request information.

Note that {category} includes information indicating the designated category. The instruction information may include guideline information indicating a guideline for an answer. The guideline information includes, for example, information that gives an instruction on clarity, neutrality, and the like of the answer.

The processing of the fourth generation processing unit 43 may include some or all of the functions of the determination unit 35. In this case, the fourth generation processing unit 43 functions as a part or all of the determination unit 35 in addition to the function of the generation unit 32 that generates the response information by using the generative AI.

For example, the fourth generation processing unit 43 may have processing of determining whether the request indicated by the request information received by the reception unit 31 is a request related to the second target set as the response target. In this case, the fourth generation processing unit 43 includes processing of the generation unit 32 and processing of the determination unit 35.

For example, the fourth generation processing unit 43 input to the generative AIs, as the input information, information including instruction information giving an instruction on generation of information indicating a response to the request indicated by the request information in a case where the request indicated by the request information received by the reception unit 31 is a request related to the second target, and thus, the fourth generation processing unit 43 can cause the generative AI to generate the response information in a case where the request indicated by the request information is a request related to the second target.

For example, in a case where the determination unit 35 determines that the request indicated by the request information is not a request related to the first target, the fourth generation processing unit 43 inputs to the generative AI, as the input information, information including instruction information that gives an instruction on generation of information indicating a response to the request indicated by the request information in a case where the request is a request related to the second target, and thus, the fourth generation processing unit 43 can collectively perform the determination processing as to whether the request is a request related to the second target and the generation processing of the response information.

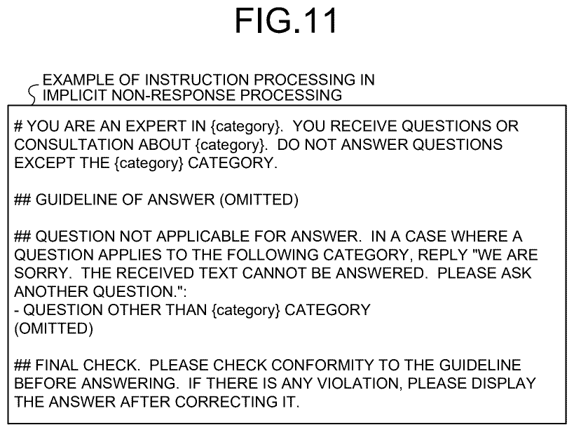

FIG. 11 is a diagram illustrating an example of the instruction information used for the explicit non-response determination processing performed by the fourth generation processing unit 43 of the processing unit 12 in the information processing apparatus 1 according to the embodiment as part of processing of the determination unit 35.

In the example illustrated in FIG. 11, the instruction information included in the input information is, for example, information of a character string “#You are an expert in {category}, you receive questions or consultation about {category}. Do not answer questions except the {category} category.”, but is not limited to such an example. Note that {category} includes information indicating the designated category. As the guideline of the answer, an incidental condition that is not limited to the designated category may be further included.

The processing by the fourth generation processing unit 43 may include processing of determining whether the request indicated by the request information received by the reception unit 31 is a request related to the first target and a request related to the second target. In this case, the fourth generation processing unit 43 also includes the processing of the generation unit 32 and the processing of the determination unit 35.

For example, the fourth generation processing unit 43 inputs to the generative AI, as the input information, information including instruction information giving an instruction on generation of information indicating a response to the request indicated by the request information in a case where the request indicated by the request information received by the reception unit 31 is not a request related to the first target but a request related to the second target, and thus, the fourth generation processing unit 43 can also cause the generative AI to generate the response information in a case where the request indicated by the request information is not a request related to the first target but a request related to the second target.

In this case, the input information includes, in addition to the instruction information, the request information, information indicating the first target, and information indicating the second target. The instruction information is, for example, information of a character string “#You are an excellent AI assistant. Determine whether a given question applies to the first target indicated below. If the given question does not apply to the first target, receive and answer questions about {category} as an expert in {category}. Do not answer questions except the {category} category.”, but is not limited to such an example. Note that {category} includes information indicating the designated category. The instruction information may include guideline information.

### [3.3.4. Evaluation Unit 33]

The evaluation unit 33 evaluates the non-response accuracy for each non-response target information combination that is a combination of two or more pieces of non-response target information among the plurality of pieces of non-response target information generated by the generation unit 32.

For example, the evaluation unit 33 can evaluate the non-response accuracy for each non-response target information combination by using the plurality of pieces of evaluation request information stored in the evaluation request information storage unit 22 and acquired by the acquisition unit 30.

As described above, each piece of evaluation request information is information indicating the first request that is a request related to the non-response target in the designated category, information indicating the second request that is a request related to the response target in the designated category, or information indicating the third request that is a request related to the non-response target regardless of the designated category.

The evaluation unit 33 determines whether it is determined that the request indicated by the evaluation request information is a request related to the non-response target in the explicit non-response determination processing using the non-response target information combination. The explicit non-response determination processing using the non-response target information combination is, for example, processing of using each of the plurality of pieces of non-response target information included in the non-response target information combination as the first target.

In a case where determining that the first request or the third request indicated by the evaluation request information is a request related to a non-response target in the explicit non-response determination processing using the non-response target information combination, the evaluation unit 33 sets an evaluation of the non-response target information combination to 1, and otherwise, sets the evaluation of the non-response target information combination to 0.

In a case where determining that the second request indicated by the evaluation request information is not a request related to a non-response target in the explicit non-response determination processing using the non-response target information combination, the evaluation unit 33 sets an evaluation of the non-response target information combination to 1, and otherwise, sets the evaluation of the non-response target information combination to 0.

The evaluation unit 33 can calculate the non-response accuracy by aggregating evaluation results and dividing the aggregation results by the number of evaluations. The evaluation unit 33 can change a weight depending on whether the request indicated by the evaluation request information is the first request, the second request, or the third request, and aggregate the evaluation results by weighted addition.

The evaluation request information may be limited to information indicating the first request, or may be limited to two or more pieces of information of the information indicating the first request, the information indicating the second request, or the information indicating the third request. The evaluation is not limited to 0 and 1, and may be, for example, −1 and 1, or a combination of other values.

The evaluation unit 33 can also evaluate the non-response accuracy of the non-response target information combination by using the language model in a case where the determination unit 35 determines, by using the keyword based natural language processing, for example, whether the request indicated by the request information from each user U is a request related to the non-response target in the explicit non-response determination processing using the non-response target information combination.

For example, the evaluation unit 33 can evaluate the non-response accuracy of the non-response target information combination for each non-response target information combination by using the third language model on the basis of the information indicating the request included in the request information from each user U and a determination result of the determination unit 35 using the keyword based natural language processing.

For example, the evaluation unit 33 inputs as the input information, to the third language model, information including instruction information that gives an instruction on determination as to whether any of the two or more pieces of non-response target information indicated by the non-response target information combination is included in the request information from the user U, and causes the third language model to output information indicating the non-response accuracy of the two or more pieces of response target information indicated by the non-response target information combination.

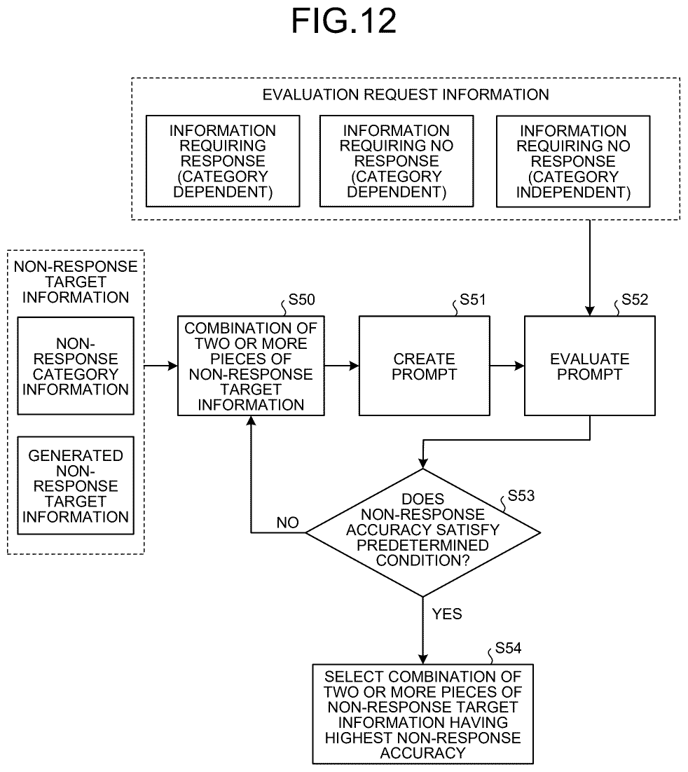

FIG. 12 is a diagram illustrating a flow of processing by the evaluation unit 33 of the processing unit 12 in the information processing apparatus 1 according to the embodiment. As illustrated in FIG. 12, the evaluation unit 33 determines a combination of two or more pieces of non-response target information from among the plurality of pieces of non-response target information (Step S50). The combination of two or more pieces of non-response target information is determined randomly or in accordance with a predetermined rule. The combination of two or more pieces of non-response target information may be, for example, a combination including m pieces of non-response target information for each non-response category. The number m is an integer of one or more.

Subsequently, the evaluation unit 33 creates a prompt (input information) including instruction information including the combination of two or more pieces of non-response target information determined in Step S50 (Step S51). Then, the evaluation unit 33 evaluates the non-response accuracy of the prompt generated in Step S51 as the non-response accuracy of the combination of two or more pieces of non-response target information determined in Step S51 (Step S52).

In Step S52, the evaluation unit 33 inputs information including the prompt generated in Step S51 and the evaluation request information as input information to the first language model for each piece of evaluation request information, and determines the non-response accuracy of the combination of two or more pieces of non-response target information determined in Step S50 on the basis of information indicating whether the request is a request indicating the first target output from the first language model for each piece of evaluation request information.

In the example illustrated in FIG. 12, each piece of evaluation request information is information requiring no response (category dependent), information requiring a response (category dependent), or information requiring no response (category independent). The information requiring no response (category dependent) is information indicating the first request that is a request related to the non-response target in the designated category. The information requiring a response (category dependent) is information indicating the second request that is a request related to the response target in the designated category. The information requiring no response (category independent) is information indicating the third request that is a request related to the non-response target regardless of the designated category.

Then, the selection unit 34 described later determines whether the non-response accuracy obtained in Step S51 satisfies a predetermined condition on the basis of the evaluation result in Step S52 (Step S53). The predetermined condition is, for example, a condition that the non-response accuracy is the highest in a case where the processing of Step S50 ends for all the combination of two or more pieces of non-response target information, or a condition that the non-response accuracy is equal to or greater than a threshold, but is not limited to such examples.

In a case where determining that the non-response accuracy obtained in Step S51 satisfies the predetermined condition (Step S53: Yes), the selection unit 34 selects the combination of two or more pieces of non-response target information in which the non-response accuracy obtained in Step S51 satisfies the predetermined condition as two or more pieces of non-response target information to be used by the determination unit 35.

In a case where the selection unit 34 determines that the non-response accuracy obtained in Step S51 does not satisfy the predetermined condition (Step S53: No), the evaluation unit 33 proceeds the processing to Step S50.

### [3.3.5. Selection Unit 34]

The selection unit 34 selects two or more pieces of non-response target information to be used by the determination unit 35 among the plurality of pieces of non-response target information on the basis of the non-response accuracy for each combination of two or more pieces of non-response target information among the plurality of pieces of non-response target information. The plurality of pieces of non-response target information are, for example, non-response category information that is information indicating the non-response category, non-response target information generated by the generation unit 32, and the like.

For example, the selection unit 34 selects two or more pieces of non-response target information to be used by the determination unit 35 on the basis of the evaluation result by the evaluation unit 33. For example, the selection unit 34 selects a non-response target information combination having the highest non-response accuracy among the non-response accuracy of each non-response target information combination as the combination of two or more pieces of non-response target information to be used by the determination unit 35.

The selection unit 34 can also select a non-response target information combination having non-response accuracy equal to or greater than a threshold for each non-response target information combination as the combination of the two or more pieces of non-response target information to be used by the determination unit 35 randomly or in accordance with a predetermined rule.

### [3.3.6. Determination Unit 35]

The determination unit 35 performs various types of determination. For example, the determination unit 35 determines whether to generate response information that is information indicating a response to the request indicated by the request information received by the reception unit 31.

The determination unit 35 determines whether to generate information indicating a response to the request indicated by the request information received by the reception unit 31 on the basis of whether the request indicated by the request information received by the reception unit 31 is a request related to the first target set as a non-response target and a request related to the second target set as a response target.

The first target is, for example, a target set as a non-response target for a designated category that is a category designated by the user U, a non-response category associated in advance with the designated category, a non-response target indicated by non-response target information generated by the generation unit 32, and the like.

The non-response category is, for example, another category (category other than the designated category) in which a boundary with the designated category is ambiguous and a probability of an appropriate response is equal to or less than a threshold, and is set in advance for each designated category, but is not limited to such an example.

For example, the determination unit 35 performs explicit non-response determination processing of determining whether the request indicated by the request information received by the reception unit 31 is a request related to the first target that is a non-response target on the basis of two or more pieces of non-response target information selected by the selection unit 34.

The two or more pieces of non-response target information selected by the selection unit 34 are two or more pieces of information among the plurality of pieces of non-response category information indicating the non-response category set in advance in the designated category and the plurality of pieces of non-response target information generated by the generation unit 32.

The first target set as the non-response target includes, for example, a target that does not depend on the designated category in addition to the target set as the non-response target for the designated category. The target that does not depend on the designated category is, for example, violation of a law, violation of social morals, slander, defamation, and the like, but is not limited to such examples.

The target that depends on the designated category and the target that does not depend on the designated category may include a target for which a response using the generative AI is not appropriate. Examples of the target for which the response using the generative AI is not appropriate include medical care, health, and finance, but are not limited to such examples.

For example, the determination unit 35 can determine whether the request indicated by the request information received by the reception unit 31 is a request related to the first target set as the non-response target by using the first language model. The first language model is, for example, a large-scale language model such as a transformer-based model or an RNN-based model, but is not limited to such examples.

The determination unit 35 inputs to the first language model, as input information, information including instruction information instructing output of information indicating whether the request indicated by the request information received by the reception unit 31 is a request related to the first target and information indicating a request indicated by the request information included in the use request. In this case, the information indicating whether the request is related to the first target is output from the first language model. In this manner, the determination unit 35 can determine whether the request indicated by the request information is a request related to the first target set as the non-response target by using the first language model.

The instruction information includes information indicating an output format. The information indicating the output format includes, for example, information output in a case where the request indicated by the request information is a request related to the first target, and information output in a case where the request indicated by the request information is not a request related to the first target.

The information output in a case where the request indicated by the request information is a request related to the first target is, for example, “true”, and the information output in a case where the request indicated by the request information is not a request related to the first target is, for example, “false”. However, the information is not limited to such examples.

The information indicating the output format may be information in a format for outputting specific information only when the request indicated by the request information is a request related to the first target. For example, the information indicating the output format is information of a character string “If the request indicated by the request information is a request related to the first target, ‘applicable’ is output, otherwise, nothing is output”, but is not limited to such an example. The information indicating the output format may be information indicating an output sample.

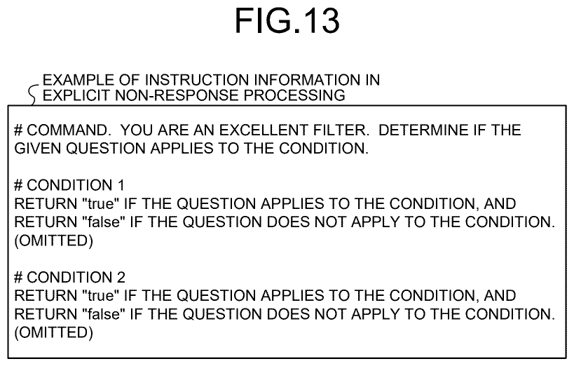

FIG. 13 is a diagram illustrating an example of the instruction information used for the explicit non-response determination processing performed by the determination unit 35 of the processing unit 12 in the information processing apparatus 1 according to the embodiment. Although details are omitted in the instruction information illustrated in FIG. 13, the information corresponding to “condition 1” includes information indicating a question about a non-response category as the information indicating a question about the first target, and the information corresponding to “condition 2” includes non-response target information generated by the generation unit 32 as the information indicating a question about the first target, but is not limited to such examples.

In the above example, the instruction information is included in the input information input to the first language model, but the first language model may be a language model learned to output information indicating whether the request indicated by the request information is a request related to the first target from the input information not including the instruction information. The first language model may be a language model learned to output information indicating whether the request indicated by the request information is a request related to the first target from the input information not including the instruction information and the information indicating the first target. In these cases, the language model is generated, for example, for each category, but is not limited to such examples.

Instead of or in addition to the first language model, the determination unit 35 can determine whether the request indicated by the request information is a request related to the first target set as the non-response target by natural language processing not using the first language model. The natural language processing not using the first language model is, for example, keyword based natural language processing. The determination unit 35 includes, for example, a first target dictionary including a plurality of keywords each directly or indirectly indicating the first target, and determines whether a keyword included in the first target dictionary is included in the request information.

In a case where the keyword included in the first target dictionary is included in the request information, the determination unit 35 determines that the request indicated by the request information is a request related to the first target set as the non-response target, and otherwise, the determination unit 35 determines that the request indicated by the request information is not a request related to the first target set as the non-response target.

The keyword based natural language processing may be natural language processing using a model. The model in this case is a model generated by machine learning using learning information including, for each piece of input information, input information and information (label information) indicating whether the request indicated by the input information is a request related to the first target. Such a model is, for example, GBDT, a neural network, or the like, but is not limited to such examples.

In a case where determining that the request indicated by the request information received by the reception unit 31 is not a request related to the first target, the determination unit 35 performs implicit non-response determination processing that determines whether the request indicated by the request information is a request related to the second target set as a response target.

The second target is a target set as a response target as described above, and it is determined whether the second target is not a non-response target by determining whether the second target is not a request related to the second target, and it can be said that the second target is a target implicitly indicating the non-response target. Therefore, as described above, it can be said that the second target to be a response target implicitly indicates a non-response determination criterion, and can be regarded as an implicit non-response determination criterion. For example, in a case where there is a category designated by the user U, the second target includes a designated category that is such a category.

For example, the determination unit 35 can determine whether the request indicated by the request information is a request related to the second target set as the response target by using the second language model. The second language model is, for example, a large-scale language model such as a transformer-based model or an RNN-based model, but is not limited to such examples. Note that the second language model may be the same language model as the first language model.

The determination unit 35 inputs to the second language model, as input information, information including instruction information giving an instruction on output of information indicating whether the request indicated by the request information is a request related to the second target and information indicating the request indicated by the request information included in the use request.

In this case, the information indicating whether the request is related to the second target is output from the second language model. In this manner, the determination unit 35 can determine whether the request indicated by the request information is a request related to the second target set as the response target by using the second language model.

The instruction information includes information indicating the second target, but the information indicating the second target may be included in the input information separately from the instruction information. The instruction information may include information indicating a request included in the request information.

The instruction information includes information indicating an output format. The information indicating the output format includes, for example, information output in a case where the request indicated by the request information is a request related to the second target, and information output in a case where the request indicated by the request information is not a request related to the second target.

The information output in a case where the request indicated by the request information is a request related to the second target is, for example, “true”, and the information output in a case where the request indicated by the request information is not a request related to the second target is, for example, “false”. However, the information is not limited to such examples.

The information indicating the output format may be information in a format for outputting specific information only when the request indicated by the request information is a request related to the second target. For example, the information indicating the output format is information of a character string “If the request indicated by the request information is a request related to the second target, ‘applicable’ is output, otherwise, nothing is output”, but is not limited to such an example. The information indicating the output format may be information indicating an output sample.

In the above example, the instruction information is included in the input information input to the second language model, but the second language model may be a language model learned to output information indicating whether the request indicated by the request information is a request related to the second target from the input information not including the instruction information.

The second language model may be a language model learned to output information indicating whether the request indicated by the request information is a request related to the second target from the input information not including the instruction information and the information indicating the second target.

Instead of or in addition to the second language model, the determination unit 35 can determine whether the request indicated by the request information is a request related to the second target set as the response target by natural language processing not using the second language model.

The natural language processing not using the second language model is, for example, keyword based natural language processing. The determination unit 35 includes, for example, a second target dictionary including a plurality of keywords each directly or indirectly indicating the second target, and determines whether a keyword included in the second target dictionary is included in the request information.

In a case where the keyword included in the second target dictionary is included in the request information, the determination unit 35 determines that the request indicated by the request information is a request related to the second target set as the response target, and otherwise, the determination unit 35 determines that the request indicated by the request information is not a request related to the second target set as the response target.

The keyword based natural language processing may be natural language processing using a model. The model in this case is a model generated by machine learning using learning information including, for each piece of input information, input information and information (label information) indicating whether the request indicated by the input information is a request related to the second target. Such a model is, for example, GBDT, a neural network, or the like, but is not limited to such examples.

Subsequently, the determination unit 35 determines whether to generate information indicating a response to the request indicated by the request information received by the reception unit 31 on the basis of a determination result of whether the request indicated by the request information received by the reception unit 31 is a request related to the second target.

For example, in a case where determining that the request indicated by the request information received by the reception unit 31 is a request related to the second target, the determination unit 35 determines to generate information indicating a response to the request indicated by the request information.

In a case where determining that the request indicated by the request information received by the reception unit 31 is not a request related to the second target, the determination unit 35 determines not to generate information indicating a response to the request indicated by the request information.

In this manner, the determination unit 35 first performs the explicit non-response determination processing, performs the implicit non-response determination processing when the explicit non-response determination criterion is not satisfied, and responds when the implicit non-response determination criterion is not satisfied. As a result, the determination unit 35 can perform highly accurate response availability determination at low cost, and can suppress inappropriate responses.

Note that the determination unit 35 can perform the explicit non-response determination processing and the implicit non-response determination processing in parallel. In this case, the determination unit 35 determines whether to generate information indicating a response to the request indicated by the request information on the basis of a determination result of the explicit non-response determination processing and a determination result of the implicit non-response determination processing.

In this case, the determination unit 35 determines to generate the information indicating the response to the request indicated by the request information in a case where the request indicated by the request information is not the request related to the first target and the request indicated by the request information is the request related to the second target, and otherwise, determines not to generate the information indicating the response to the request indicated by the request information. In this manner, the information processing apparatus 1 can also suppress an inappropriate response.

The determination unit 35 can also perform processing in the order of the implicit non-response determination processing and the explicit non-response determination processing. In this case, the explicit non-response determination processing can be performed only in a case where it is determined in the implicit non-response determination processing that the request indicated by the request information is a request related to the second target. In this manner, the information processing apparatus 1 can also suppress an inappropriate response.

In this manner, the determination unit 35 can determine whether to generate the information indicating the response to the request indicated by the request information on the basis of whether the request indicated by the request information is a request related to the first target set as the non-response target and a request related to the second target set as the response target.

### [3.3.7. Providing Unit 36]

The providing unit 36 provides the user U and the employee O with various types of information. For example, the providing unit 36 provides the user U with various types of information by transmitting various types of information to the terminal device 2 via the communication unit 10 and the network N. The providing unit 36 provides the employee O with various types of information by transmitting various types of information to the terminal device 3 via the communication unit 10 and the network N.

In a case where the determination unit 35 determines to generate the response information, the providing unit 36 provides the user U with the response information generated by using the generative AI as information indicating a response to the request indicated by the request information received by the reception unit 31.

For example, the providing unit 36 transmits response information generated by using the generative AI generated by the generation unit 32 to the terminal device 2 that has transmitted the use request to provide the user U with the response information generated by using the generative AI.

For example, in a case where the request indicated by the request information is a question in the Q & A service, when the user U accesses a page indicating an answer to the question from the user U, the providing unit 36 can provide the user U with the page indicating the answer to the question of the user U.

In a case where the response information is not generated by the generation unit 32 by using the generative AI, the providing unit 36 provides the user U with the non-response information. For example, in a case where the determination unit 35 determines that the request indicated by the request information is a request related to the first target, or in a case where the determination unit 35 determines that the request indicated by the request information is not a request related to the second target, the providing unit 36 provides the user U with the non-response information.

The non-response information is, for example, information of character information “We are sorry. The target is a non-response target, and the request cannot be responded to”. For example, in a case where the request indicated by the request information is a request of a Q & A service, the non-response information is, for example, information of character information “We are sorry. The question cannot be answered because it is a question not to applicable for answer”. Note that the non-response information may include information explicitly indicating that the request is related to the first target or is not related to the second target.

### [4. Processing Procedure]

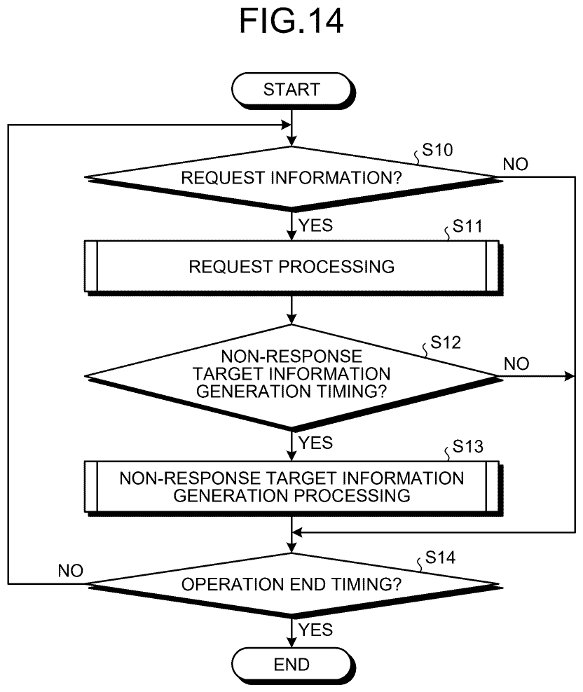

Next, a procedure of information processing by the processing unit 12 of the information processing apparatus 1 according to the embodiment will be described. FIG. 14 is a flowchart illustrating an example of the information processing by the processing unit 12 of the information processing apparatus 1 according to the embodiment.

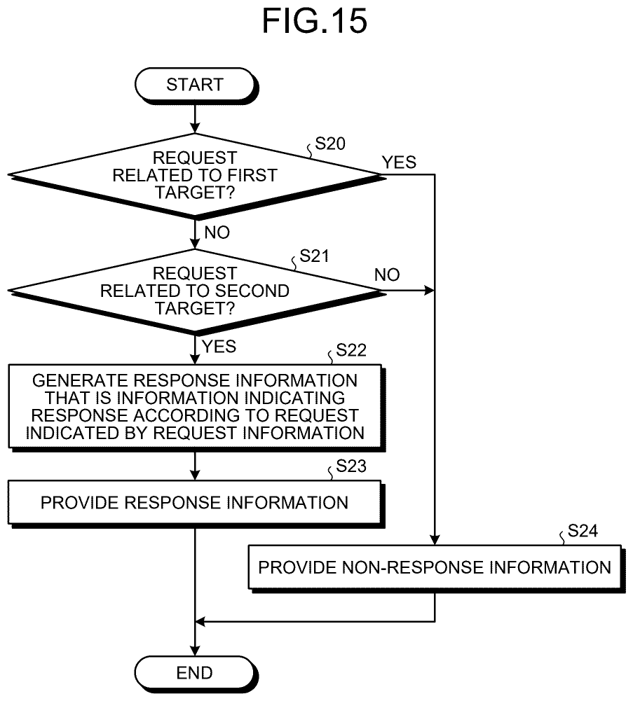

As illustrated in FIG. 14, the processing unit 12 of the information processing apparatus 1 determines whether the request information has been received (Step S10). In a case where it is determined that the request information has been received (Step S10: Yes), the processing unit 12 performs request processing (Step S11). The request processing in Step S11 is processing in Steps S20 to S24 illustrated in FIG. 15, and will be described in detail later.

In a case where the processing in Step S11 ends or in a case where it is determined that the request information has not been received (Step S10: No), the processing unit 12 determines whether a non-response target information generation timing has come (Step S12). The non-response target information generation timing is, for example, a timing at which a generation request is made from the terminal device 3 or a timing that arrives at a predetermined cycle, but is not limited to such examples.

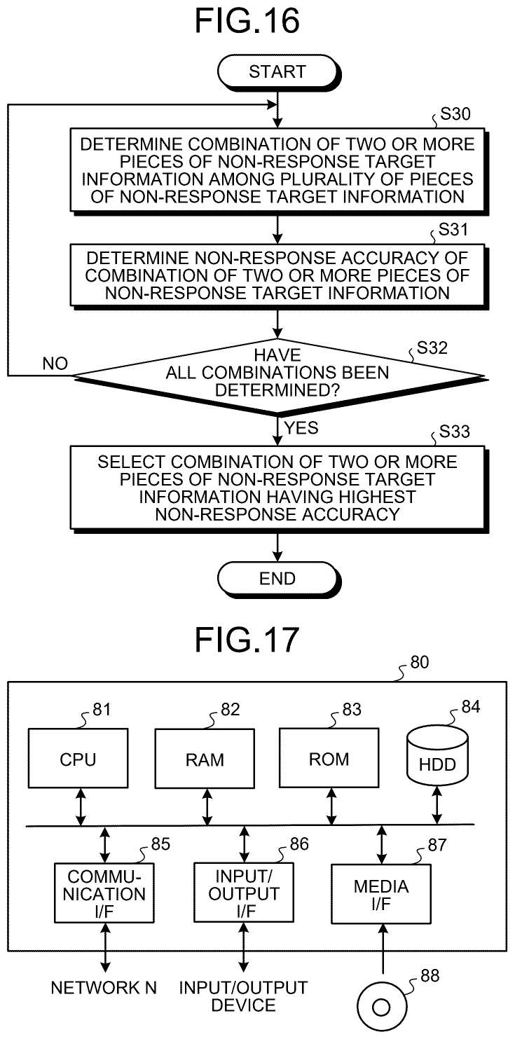

In a case where determining that the non-response target information generation timing has come (Step S12: Yes), the processing unit 12 performs non-response target information generation processing (Step S13). The non-response target information generation processing in Step S13 is processing in Steps S30 to S33 illustrated in FIG. 16, and will be described in detail later.

In a case where the processing in Step S13 ends, and in a case where it is determined that the non-response target information generation timing has not come (Step S12: No), the processing unit 12 determines whether an operation end timing has come (Step S14). For example, in a case where the power of the information processing apparatus 1 is turned off, the processing unit 12 determines that the operation end timing has come.

In a case where determining that the operation end timing has not come (Step S14: No), the processing unit 12 proceeds the processing to Step S10, and in a case where determining that the operation end timing has come (Step S14: Yes), the processing unit 12 ends the processing illustrated in FIG. 14.

FIG. 15 is a flowchart illustrating an example of the request processing by the processing unit 12 of the information processing apparatus 1 according to the embodiment. As illustrated in FIG. 15, the processing unit 12 of the information processing apparatus 1 determines whether the request indicated by the request information determined to be received in Step S10 is a request related to the first target (Step S20).

Subsequently, in a case where determining that the request indicated by the request information is not a request related to the first target (Step S20: No), the processing unit 12 determines whether the request indicated by the request information is a request related to the second target (Step S21). In a case where determining that the request indicated by the request information is a request related to the second target (Step S21: Yes), the processing unit 12 generates response information that is information indicating a response according to the request indicated by the request information (Step S22). Then, the response information generated in Step S22 is provided (Step S23).

In a case where determining that the request indicated by the request information is a request related to the first target (Step S20: Yes) or in a case where determining that the request indicated by the request information is not a request related to the second target (Step S21: No), the processing unit 12 provides non-response information (Step S24).

FIG. 16 is a flowchart illustrating an example of the non-response target information generation processing by the processing unit 12 of the information processing apparatus 1 according to the embodiment. As illustrated in FIG. 16, the processing unit 12 determines a combination of two or more pieces of non-response target information from among the plurality of pieces of non-response target information (Step S30).

Subsequently, the processing unit 12 determines the non-response accuracy of the combination of two or more pieces of non-response target information (Step S31). Then, the processing unit 12 determines whether all the combinations of two or more pieces of non-response target information have been determined (Step S32).

When determining that not all the combinations have been determined (Step S32: No), the processing unit 12 proceeds the processing to Step S30. When determining that all the combinations have been determined (Step S32: Yes), the processing unit 12 selects a combination of two or more pieces of non-response target information having the highest non-response accuracy as information to be used in the explicit non-response determination processing (Step S33), and ends the processing illustrated in FIG. 16.

### [5. Modifications]

In the above example, it has been described that the generative AI is text generation AI, but the generative AI is not limited to the text generative AI, and may be image generative AI, multimodal generative AI, or the like. The image generative AI is AI that generates an image from text, and is, for example, Generative Adversarial Networks (StackGAN), AttnGAN, Text-to-Image (T2I) with Transformers, Diffusion model, or the like, but is not limited to such examples. Examples of Diffusion model include DALL-E and Stable-Diffusion.

The multimodal generative AI is, for example, generative AI that generates at least one of a text, an image, or a voice from at least one of a text, an image, or a voice. The multimodal generative AI is, for example, GPT-4 Turbo with vision, gemini, Chameleon Multimodal Model (CM3Leon), or the like, but is not limited to such examples.

In the above example, an example has been described in which the non-response category corresponding to the designated category is set in advance as the first target. However, the present invention is not limited to such an example, and the non-response target corresponding to the designated category may be set in advance as the first target instead of the non-response category corresponding to the designated category. In this case, the generation unit 32 can also generate the non-response target information by processing similar to the case of the non-response category on the basis of the information indicating the non-response target set in advance as the first target in the designated category.

### [6. Hardware Configuration]

The information processing apparatus 1 according to the above embodiment is implemented by a computer 80 having a configuration as illustrated in FIG. 17, for example. FIG. 17 is a hardware configuration diagram illustrating an example of the computer 80 that implements a function of the information processing apparatus 1 according to the embodiment. The computer 80 includes a CPU 81, a RAM 82, a read only memory (ROM) 83, a hard disk drive (HDD) 84, a communication interface (I/F) 85, an input/output interface (I/F) 86, and a media interface (I/F) 87.

The CPU 81 operates on the basis of a program stored in the ROM 83 or the HDD 84, and controls each unit. The ROM 83 stores a boot program executed by the CPU 81 when the computer 80 is activated, a program depending on a hardware of the computer 80, and the like.

The HDD 84 stores a program executed by the CPU81, data used by the program, and the like. The communication interface 85 receives data from other devices via the network N (see FIG. 2), sends the data to the CPU 81, and transmits data generated by the CPU 81 to other devices via the network N.

The CPU 81 controls output devices such as a display and a printer, and input devices such as a keyboard and a mouse via the input/output interface 86. The CPU 81 acquires data from the input devices via the input/output interface 86. The CPU 81 outputs the generated data to the output devices via the input/output interface 86.

The media interface 87 reads a program or data stored in a recording medium 88 and provides the program or data to the CPU 81 via the RAM 82. The CPU 81 loads the program from the recording medium 88 onto the RAM 82 via the media interface 87, and executes the loaded program. The recording medium 88 is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 80 functions as the information processing apparatus 1 according to the embodiment, the CPU 81 of the computer 80 implements a function of the processing unit 12 by executing the program loaded on the RAM82. The HDD 84 stores data in the storage unit 11. The CPU 81 of the computer 80 reads and executes these programs from the recording medium 88, but as another example, these programs may be acquired from another device via the network N.

### [7. Others]

Of the processing described in the above embodiment, all or a part of the processing described as being automatically performed can be manually performed, or all or a part of the processing described as being manually performed can be automatically performed by a known method. In addition, the processing procedure, specific name, and information including various data and parameters illustrated in the document and the drawings can be arbitrarily changed unless otherwise specified. For example, the various types of information illustrated in the drawings are not limited to the illustrated information.

Each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in an arbitrary unit in accordance with various loads, usage conditions, and the like.

For example, the above information processing apparatus 1 may be implemented by a terminal device and a server computer, may be implemented by a plurality of server computers, or may be implemented by calling an external platform or the like with an API, network computing, or the like depending on functions, so that the configuration can be flexibly changed.

The above embodiment and modifications can be appropriately combined within a range that does not contradict processing contents.

### [8. Effects]

As described above, the information processing apparatus 1 according to the embodiment includes the reception unit 31, the determination unit 35, and the providing unit 36. The reception unit 31 receives the information indicating the request of the user U. The determination unit 35 determines whether to generate information indicating a response to the request indicated by the information received by the reception unit 31. The providing unit 36 includes the providing unit 36 that provides the user U with the response information generated by using the generative AI as the information indicating the response to the request in a case where the determination unit 35 determines to generate the information indicating the response. The determination unit 35 determines whether to generate information indicating the response to the request indicated by the information received by the reception unit 31 on the basis of whether the request indicated by the information received by the reception unit 31 is a request related to the first target set as the non-response target and a request related to the second target set as the response target. As a result, the information processing apparatus 1 can suppress an inappropriate response.

The first target includes a target set as a non-response target for a category designated by the user U. As a result, the information processing apparatus 1 can further suppress an inappropriate response.

The second target includes a category designated by the user U. As a result, the information processing apparatus 1 can further suppress an inappropriate response.

The determination unit 35 determines by using the first language model whether the request indicated by the information received by the reception unit 31 is a request related to the first target. As a result, the information processing apparatus 1 can further suppress an inappropriate response.

The determination unit 35 determines by using the second language model whether the request indicated by the information received by the reception unit 31 is a request related to the second target. As a result, the information processing apparatus 1 can further suppress an inappropriate response.

The information processing apparatus 1 includes the generation unit 32 that generates the information indicating the first target by using the third language model. As a result, the information processing apparatus 1 can further suppress an inappropriate response.

The generation unit 32 inputs, to the language model, information including non-response category information indicating a non-response category that is a category different from the designated category as a category designated by the user U and is associated with the designated category in advance as a non-response category, and causes the language model to generate information indicating a risk as information indicating the first target. As a result, the information processing apparatus 1 can further suppress an inappropriate response.

The embodiments of the present application have been described in detail with reference to the drawings, but are merely examples, and the present invention can be implemented in other forms to which various modifications and improvements have been made on the basis of the knowledge of those skilled in the art, including the aspects described in the disclosure of the invention.

The “section, module, unit” described above can be read as “means”, “circuit”, or the like. For example, the acquisition unit can be replaced with an acquisition means or an acquisition circuit.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a reception unit that receives information indicating a request of a user;
a determination unit that determines whether to generate information indicating a response to the request indicated by the information received by the reception unit; and
a providing unit that provides the user with response information generated by using a generative AI as the information indicating the response to the request in a case where the determination unit determines to generate the information indicating the response, wherein
the determination unit
determines whether to generate the information indicating the response to the request indicated by the information received by the reception unit on a basis of whether the request indicated by the information received by the reception unit is a request related to a first target set as a non-response target and a request related to a second target set as a response target.

2. The information processing apparatus according to claim 1, wherein
the first target
includes a target set as a non-response target for a category designated by the user.

3. The information processing apparatus according to claim 1, wherein
the second target
includes a category designated by the user.

4. The information processing apparatus according to claim 1, wherein
the determination unit
determines by using a first language model whether the request indicated by the information received by the reception unit is a request related to the first target.

5. The information processing apparatus according to claim 1, wherein
the determination unit
determines by using a second language model whether the request indicated by the information received by the reception unit is a request related to the second target.

6. The information processing apparatus according to claim 4, further comprising
a generation unit that generates information indicating the first target by using the third language model.

7. The information processing apparatus according to claim 6, wherein
the generation unit
inputs, to a language model, information including non-response category information indicating a non-response category that is a category different from a designated category as a category designated by the user and is associated with the designated category in advance as a non-response category, and causes the language model to generate information indicating a risk as the information indicating the first target.

8. An information processing method that is executed by a computer, the method comprising:
receiving information indicating a request of a user;
determining whether to generate information indicating a response to the request indicated by the information received in the receiving; and
providing the user with response information generated by using a generative AI as the information indicating the response to the request in a case where it is determined in the determining to generate the information indicating the response, wherein
the determining includes
determining whether to generate the information indicating the response to the request indicated by the information received in the receiving on a basis of whether the request indicated by the information received in the receiving is a request related to a first target set as a non-response target and a request related to a second target set as a response target.

9. A non-transitory computer readable storage medium that stores an information processing program, the storage medium causing a computer to execute a process comprising:
receiving information indicating a request of a user;
a determining whether to generate information indicating a response to the request indicated by the information received in the receiving; and
providing the user with response information generated by using a generative AI as the information indicating the response to the request in a case where it is determined in the determining to generate the information indicating the response, wherein
the determining includes
determining whether to generate the information indicating the response to the request indicated by the information received in the receiving on a basis of whether the request indicated by the information received in the receiving is a request related to a first target set as a non-response target and a request related to a second target set as a response target.
